(19) United States
(12) Patent Application Publication
(10) Pub. No.: US 2025/0018898 A1
(43) Pub. Date: Jan. 16, 2025

(54) YOUR'E CAUGHT

(71) Applicant: Oseolia Hambrick, Virginia Beach, VA (US)

(72) Inventor: Oseolia Hambrick, Virginia Beach, VA (US)

(21) Appl. No.: 18/199,279

(22) Filed: May 18, 2023

Related U.S. Application Data
(60) Provisional application No. 63/389,405, filed on Jul. 15, 2022.

(51) Int. Cl. B60R 25/30; B60R 25/102; B60R 25/33; H04N 5/77; H04N 7/18

(52) U.S. Cl. CPC B60R 25/305; B60R 25/102; B60R 25/33; H04N 5/77; H04N 7/181

(57) ABSTRACT

Described herein is a vehicle security system utilizing a plurality of cameras placed within an interior of the vehicle and at each side of an exterior of the vehicle. The system including a central storage apparatus on the vehicle for capturing image data for remote retrieval. The central storage apparatus on the vehicle is within a fireproof container and having an optional GPS locator.

### FIELD OF THE INVENTION

The invention relates generally to a vehicle security system. More particularly, the invention of the present disclosure relates to a vehicle security system utilizing a plurality of cameras embedded within vehicle structures and in communication with a dedicated storage apparatus within a fireproof compartment in the vehicle.

### BACKGROUND

Currently there are a number of solutions for car alarms. One of these solutions attempts to utilize the common audible vehicle alarm, but this solution fails to meet the needs of the market because some cars may not have it and it only functions to deter. Another solution attempts to utilize a dash cam or other similar recording device, but this solution is similarly unable to meet the needs of the market because a dash cam does not cover all areas of the car.

### SUMMARY OF THE INVENTION

It would be advantageous to have an apparatus that is specifically configured for recording and capturing images from several locations within a vehicle including both interior and exterior position. Preferably, this apparatus is smartphone compatible and utilizes a storage system that is safe from fire and theft. Therefore, there currently exists a need in the market for an apparatus that records footage from several locations to capture and deter a break-in or attempted break-in for a vehicle.

The invention advantageously fills the aforementioned deficiencies by providing a vehicle security system, which provides audio and video evidence for break-ins and crashes.

The invention can generically be described as a built-in car security system.

The apparatus has customizable cameras, wherein the cameras can be placed in a multitude and positions depending upon a given vehicles structure.

The apparatus has an audio recorder.

The apparatus fulfills the need for a vehicle recording system to capture evidence related to a break-in.

Among other things, it is an advantage of the invention to provide a vehicle security system that does not suffer from any of the problems or deficiencies associated with prior solutions.

It is still further an advantage of the invention to be smartphone compatible.

Still further, the apparatus has a GPS device for positional and location tracking.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 shows the front of device.

FIG. 2 shows the side of device.

FIG. 3 shows the top of device.

FIG. 4 shows the perspective view of device.

FIG. 5 shows the name of the system You're Caught and Drawing show that it could be placed on any vehicle.

FIG. 6 shows the person breaking-in car.

FIG. 7 shows two cameras facing the interior or angled out.

FIG. 8 shows two cameras on the front bumper, two on the back, and one on the drivers and passengers side total coverage.

FIG. 9 shows recording device in truck of vehicle and You're Caught App.

FIG. 10 shows someone has broken into the vehicle.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

The invention is generically described as a vehicle security system.

The invention is an audio and video vehicle security system utilizing a plurality of embedded cameras placed on and within vehicle surfaces and structures for capturing images from an exterior and an interior of the vehicle.

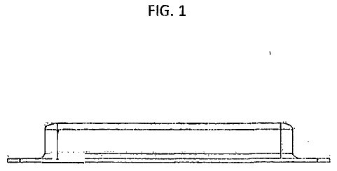

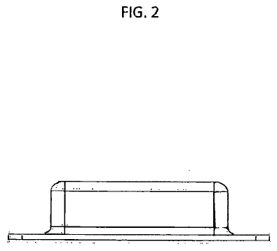

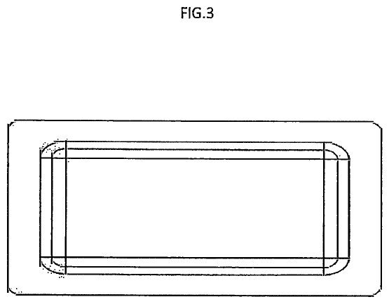

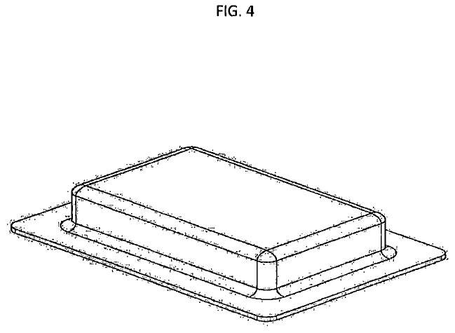

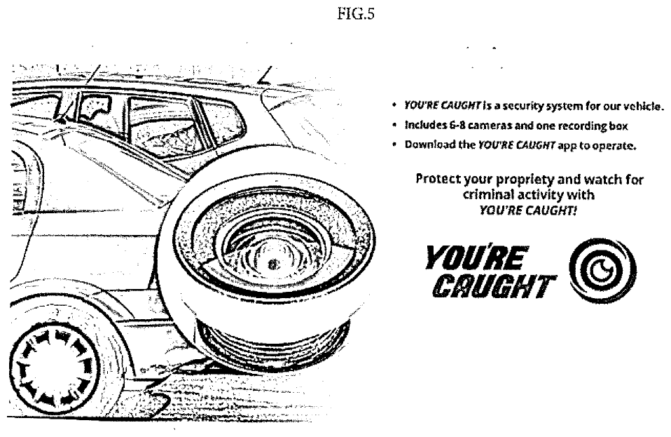

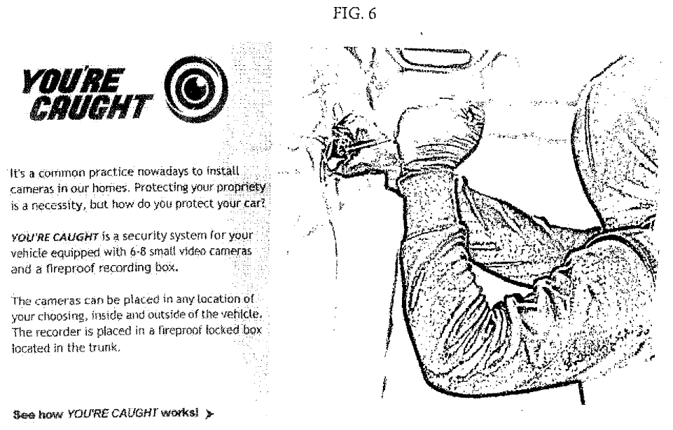

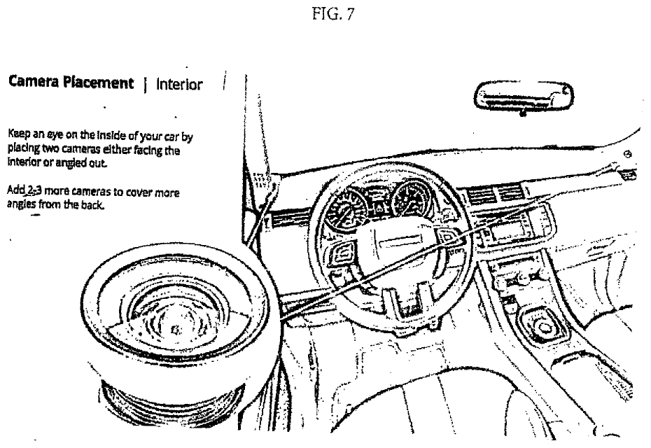

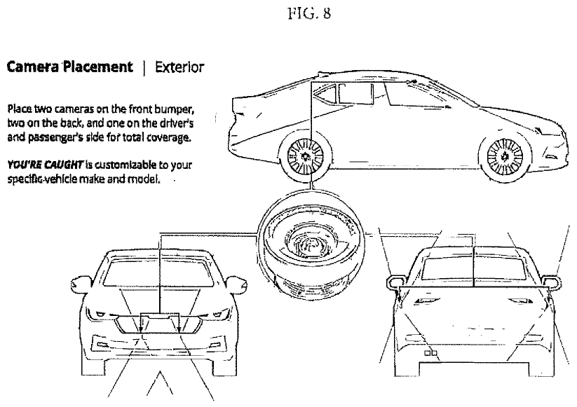

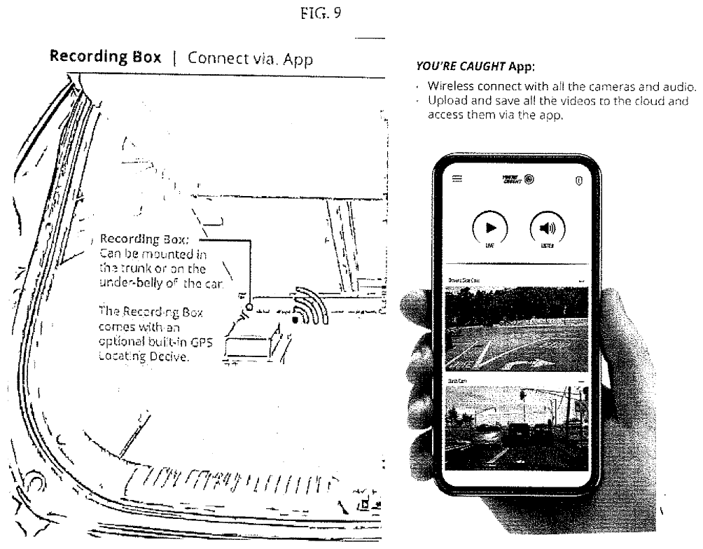

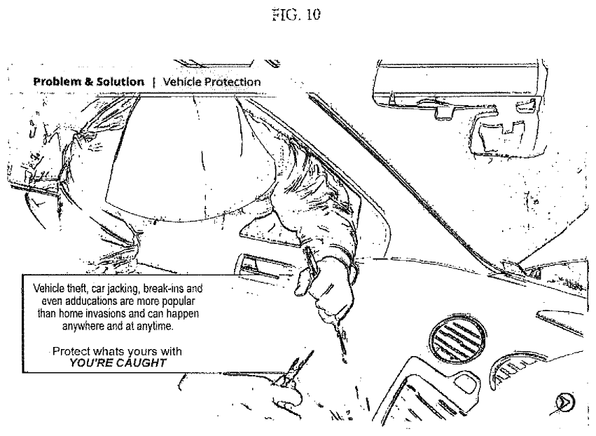

Referring to the figures, FIG. 1 to FIG. 10 shows a vehicle security system according to the present disclosure and generally referred to herein as the device. The device comprises a plurality of cameras (preferably 6 to 8 for full coverage of vehicle interior and exterior areas) having an audio recorder, a fireproof storage apparatus, and an optional GPS tracking locator. The apparatus of the present disclosure generally provides multiple cameras linked together and in communication with a central database to store, retrieve, broadcast, and transmit images. The central database is preferably placed on board the vehicle (trunk/rear compartment/underside) and within a fireproof storage container or box. In use, a user will purchase a group of linked cameras, the storage container, and utilize an application for the viewing and retrieval of captured images. The user will install or have the plurality of cameras installed into the vehicle. Suggested vehicle locations for camera placement are passenger compartment pillars facing fore and aft and angled to capture the entire vehicle interior and at least on each side of the vehicle exterior. The device is generally described as providing a customizable, compact, and smartphone compatible solution to capture images for safety and security purposes.

Various related embodiments of the invention are also described in Appendix A, which is incorporated herein by reference in its entirety.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

The invention claimed is:

1. A vehicle security system utilizing a plurality of cameras positioned on both an exterior and within an interior of the vehicle, as is herein shown and described.

2. A vehicle security system, the system including a plurality of cameras capable of recording video and audio, a central storage device located on the vehicle and in communication with each camera of the plurality of cameras, the central storage device secured within a fireproof container, and an application hosted on an internet connected device for reviewing captured images from the plurality of cameras, as is herein shown and described.

3. A vehicle security system as in claim 2, wherein the system includes a GPS location device.
